(19) United States
(12) Patent Application Publication
(10) Pub. No.: US 2007/0153025 A1
(43) Pub. Date: Jul. 5, 2007

(54) METHOD, APPARATUS, AND SYSTEM FOR ENCODING AND DECODING A SIGNAL ON A VIEWABLE PORTION OF A VIDEO

(76) Inventors: Owen Robert Mitchell, EDMOND, OK (US); Sanjeev Agarwal, ROLLA, MO (US); Gerard Sequeira, ROLLA, MO (US); Jerry Tichenor, ROLLA, MO (US); James L. Drewniak, ROLLA, MO (US)

Correspondence Address: HOVEY WILLIAMS LLP, 2405 GRAND BLVD., SUITE 400, KANSAS CITY, MO, 64108, US

(21) Appl. No.: 11/611,527

(22) Filed: Dec. 15, 2006

Related U.S. Application Data
(60) Provisional application No. 60/754,880, filed on Dec. 29, 2005.

(51) Int. Cl. G09G 5/10

(52) U.S. Cl. 345/690

(57) ABSTRACT

Various embodiments of the present invention provide a system that is operable to encode a signal within a video by increasing a brightness of a first portion of a first frame by less than about five percent, decreasing a brightness of a second portion of the first frame by less than about five percent, and storing the first frame as a portion of the video. The encoded signal may be decoded by determining the difference in the brightness of the first portion from the brightness of the second portion. Such a configuration allows signals to be encoded on viewable portions of videos for use on any type of display while being generally imperceptible to viewers watching the videos.

### RELATED APPLICATION

The present non-provisional application claims the benefit of U.S. Provisional Patent Application No. 60/754,880, entitled “METHOD FOR TRANSMITTING DATA ON VIEWABLE PORTION OF VIDEO AND MOTION PICTURE IMAGES,” filed Dec. 29, 2005. The identified provisional application is incorporated herein by specific reference.

### BACKGROUND OF THE INVENTION

1. Field of the Invention

Embodiments of the present invention relate to methods and systems for encoding signals within videos and images. More particularly, various embodiments of the present invention relate to a method, apparatus, and system for encoding and decoding a signal on a viewable portion of a video.

2. Description of the Related Art

It is often desirable to encode signals on viewable portions of videos to enable data to be simultaneously transmitted along with a viewable image. Prior art encoding methods typically employ horizontal line scan technology to allow signal decoding based on timing measurements. Unfortunately, horizontal line scan technology, also known as cathode ray timing, requires the use of cathode ray tube (CRT) monitors and televisions. Thus, horizontal line scan technology cannot be employed to decode signals encoded within viewable portions of video displayed on increasingly popular projection, plasma, liquid crystal display (LCD), and digital light processing (DLP™) televisions and displays.

### SUMMARY OF THE INVENTION

Embodiments of the present invention solve the above-described problems and provide a distinct advance in the art of signal encoding and decoding. More particularly, various embodiments of the invention relate to a method, apparatus, and system for encoding and decoding a signal on a viewable portion of a video.

The system is generally operable to encode signals within a video by increasing a brightness of a first portion of a first frame by less than about five percent, decreasing a brightness of a second portion of the first frame by less than about five percent, and storing the first frame as a portion of the video. The encoded signal may be decoded when the video is displayed on a television or other display by determining a difference in the brightness of the first portion from the brightness of the second portion. These steps may be repeated to encode signals or portions of signals over a plurality of frames within the video.

Such a configuration allows signals to be encoded on viewable portions of videos for use on any type of display while being generally imperceptible to viewers watching the videos. Further, such encoding and decoding of signals using the viewable portions of videos may be performed even if the videos are compressed for storage and/or transmission purposes and then decompressed for display.

Other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a block diagram showing various equipment operable to be utilized by various embodiments of the present invention;

FIG. 2 is block diagram of portions of a receiver configured in accordance with various preferred embodiments of the present invention, the signal receiver shown including two photodiodes;

FIG. 3 is a schematic diagram of various portions of the receiver of FIG. 2;

FIG. 4 is block diagram of portions of a receiver configured in accordance with various preferred embodiments of the present invention, the receiver shown including two partially masked photodiodes;

FIG. 5 is a schematic diagram of various portions of the receiver of FIG. 4;

FIG. 6 is block diagram of portions of a signal receiver configured in accordance with various preferred embodiments of the present invention, the receiver shown including one photodiode;

FIG. 7 is a schematic diagram of various portions of the receiver of FIG. 6;

FIG. 8 is an exemplary screen display showing a first video frame, the first frame shown including a first portion having increased brightness;

FIG. 9 is another exemplary screen display showing second video frame, the second video frame shown including a second portion having increased brightness;

FIG. 10 is a diagram showing an exemplary signal generated by various embodiments of the present invention;

FIG. 11 is a block diagram showing some of the steps operable to be performed by various embodiments of the present invention to encode a signal;

FIG. 12 is another block diagram showing some other steps operable to be performed by various embodiments of the present invention to decode a signal; and

FIG. 13 is a diagram showing various exemplary signals operable to be generated by the receiver illustrated in FIGS. 2-3.

The drawing figures do not limit the present invention to the specific embodiments disclosed and described herein. The drawings are not necessarily to scale, emphasis instead being placed upon clearly illustrating the principles of various embodiments of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

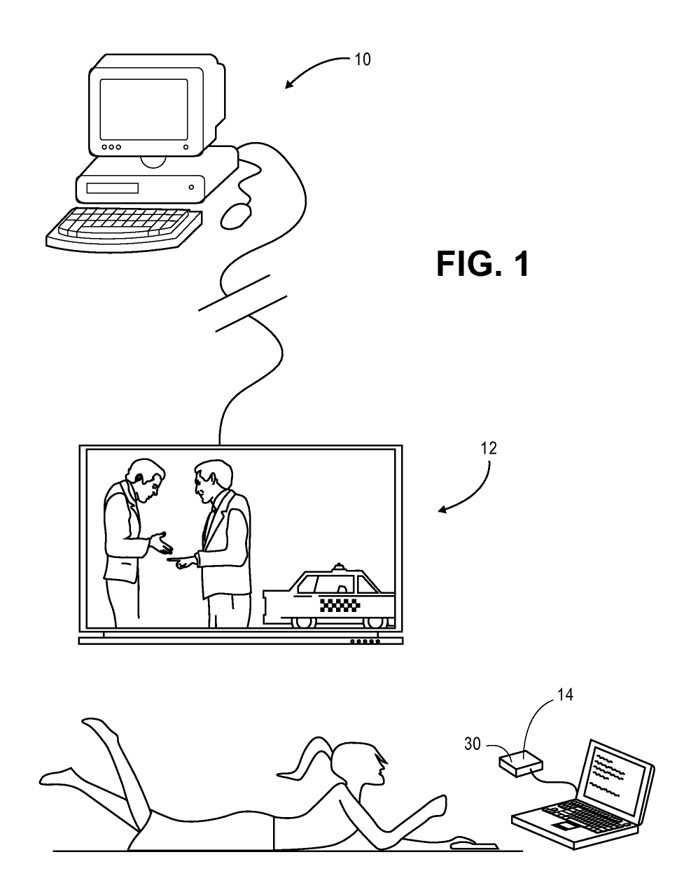

Methods consistent with the present teachings are especially well-suited for implementation by a computing element, such as the computer 10 illustrated in FIG. 1. The computer 10 may be a part of a computer network that includes one or more client computers and one or more server computers interconnected via a communications system such as an intranet or the internet. In some embodiments, the computer 10 may comprise a plurality of computers or computing devices interconnected via the communications system. It will be appreciated, however, that the principles of the present invention are useful independently of a particular implementation, and that one or more of the steps described herein may be implemented without the assistance of the computer 10.

Embodiments of the present invention can be implemented in hardware, software, firmware, or combinations thereof. In some embodiments, at least some portions of the invention are implemented with a computer program. The computer program and equipment described herein are merely examples of a program and equipment that may be used to implement the present invention and may be replaced with other software and computer equipment without departing from the scope of the present teachings.

Computer programs consistent with the present teachings can be stored in or on a computer-readable medium residing on or accessible by the computer 10 for instructing the computer 10 to implement various methods of the present invention as described herein. The computer program preferably comprises various code segments operable for execution to implement logical functions in the computer 10 and/or other computing devices coupled with computer 10. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this application, a “computer-readable medium” can be any means that can contain, store, communicate, propagate or transport the program for use by or in connection with one or more computing devices. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or flash memory), an optical fiber, and a portable compact disc (CD) or a digital video disc (DVD). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The computer 10 is preferably operable to modify video data, as is discussed in more detail below, for presentation on a television 12. The computer 10 may be operable for coupling with the television 12 through wired or wireless connections, including the Internet, radio frequency broadcasts, broadcast cable networks, combinations thereof, and the like. In some embodiments, the computer 10 is operable to store video data on a portable medium, such as a magnetic or optical medium, for playback by the television 12. Thus, the computer 10 may be operable to store video data on a video compact disc (VCD), a digital video disc (DVD), a Blu-ray disc (BD), a High Definition digital video disc (HD-DVD), a flash memory element, a hard disk drive, a computing or broadcast network, combinations thereof, etc.

The computer 10 may couple with televisions of any configuration, type, or format. The television 12 may comprise any electrical monitor operable to present or project information on one or more screens. Thus, television and monitor are used interchangeably herein. In some embodiments, the television 12 may comprise CRT televisions, forward and rear projection systems, LCD televisions and LCD projection systems, DLP projection systems, plasma displays, combinations thereof, etc. Thus, the television 12 employed and/or utilized by various embodiments of the present invention is not limited to any particular format or configuration.

Various embodiments of the present invention preferably employ a receiver 14 operable to decode a signal presented on video displayed by the television 12. The receiver 14 preferably includes at least one photodiode 16 operable to detect the brightness of at least a portion of an image displayed by the television 12, as is discussed in more detail below. However, the receiver 14 may include any optical-sensing elements and brightness-detecting elements and is not limited to the photodiodes discussed herein. In some embodiments, the photodiode 16 may include a S6436 photodiode distributed by Hamamatsu®.

Preferably, the receiver 14 includes a first photodiode 18 and a second photodiode 20 operable to detect the brightness of at least two portions of an image displayed by the television 12. The photodiodes 18, 20 may be coupled together or commonly positioned to provide a desired field-of-view for each photodiode 18, 20.

In some embodiments, the receiver 14 may include at least one photodiode for each frame portion utilized in steps 102, 104, 202, and 204 discussed below. Thus, for example, where two frame portions are used to encode a signal, the receiver 14 preferably includes two photodiodes, such as the photodiodes 18, 20 discussed above. Further, in some embodiments, the receiver 14 may include more than one photodiode for each frame portion, such as where two photodiodes are used to detect the brightness of one frame portion.

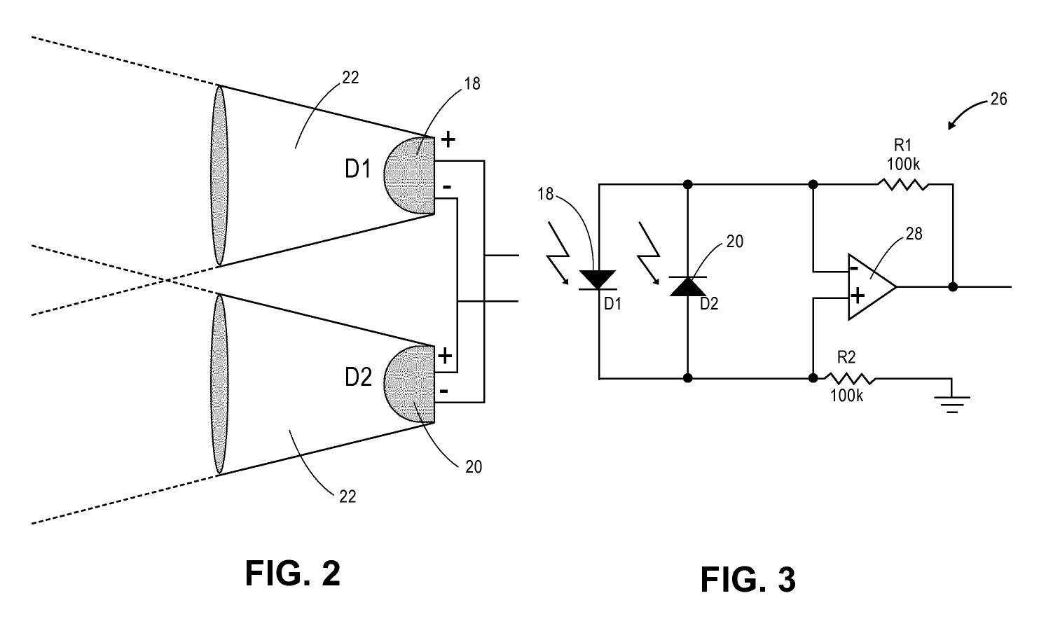

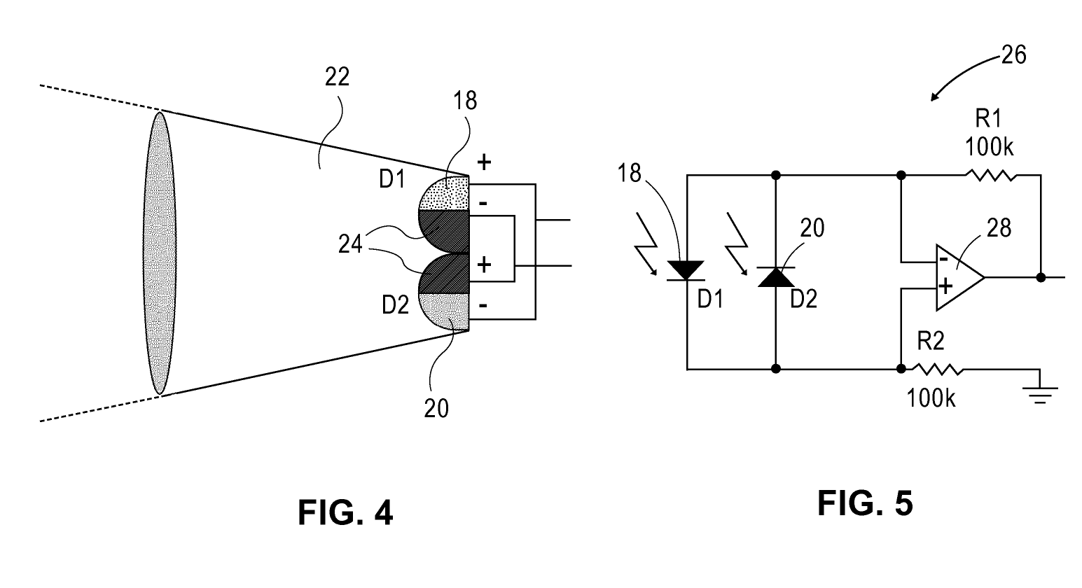

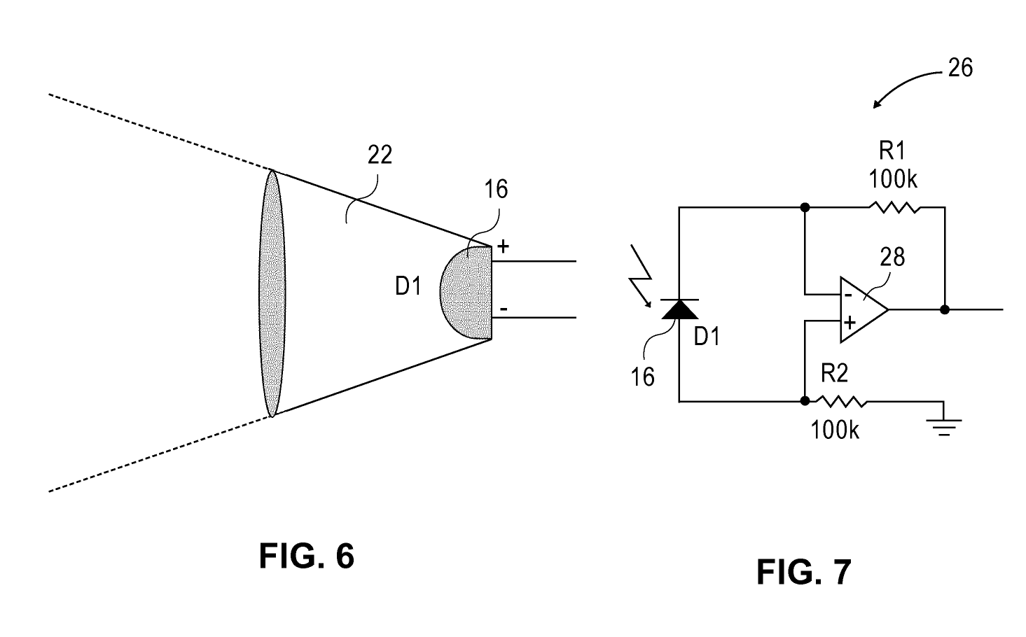

The receiver 14 may also include at least one field-of-view (FOV) cone 22 to facilitate orientation of the photodiode 16 or photodiodes 18, 20 towards appropriate portions of the television 12, such as the frame portions discussed above. For example, as shown in FIG. 2, each photodiode 18, 20 may be coupled with a FOV cone 22 to establish a desired field-of-view for each photodiode 18, 20. Alternatively, as shown in FIG. 4, the photodiodes 18, 20 may employ a single FOV cone 22 to establish a desired field-of-view. In embodiments where the photodiodes 18, 20 employ a single FOV cone 22, a masked portion 24 is preferably provided on each photodiode 18, 20 to prevent the photodiodes 18, 20 from detecting the brightness of the same portion of the image, or the same frame portion, displayed on the television 12. Alternatively, an opaque barrier may be placed between the two photodiodes 18, 20 and extend forward so that each diode is exposed to a separate field of view. As shown in FIG. 6, in embodiments where only one photodiode 16 is employed, a single FOV cone 22 may be utilized to establish a desired field-of-view.

The FOV cone 22 may be any element, structure, or material operable to substantially block visible light to establish a desired field-of-view for the photodiode 16 or photodiodes 18, 20. Thus, the FOV cone 22 may be formed from any generally opaque material. In some embodiments, as shown in FIGS. 2, 4, and 6, the FOV cone 22 may be substantially conical. However, in other embodiments the FOV cone 22 may be non-conical and present other configurations, such as rectangular, triangular, and non-uniform configurations.

The receiver 14 additionally includes circuitry 26 operable to receive a signal from the photodiode 16 or photodiodes 18, 20. In embodiments employing the photodiodes 18, 20, the circuitry 26 is operable to determine a difference in brightness between the portions of the television 12 to which each photodiode 18, 20 corresponds, such as various frame portions. For instance, if the first photodiode 18 is orientated towards a first portion of the television 12, corresponding to a first frame portion, and if the second photodiode 20 is oriented towards a second portion of the television 12, corresponding to a second frame portion, then the circuitry 26 is operable to determine a difference in brightness between the first portion and the second portion of the frame and based upon the difference, decode at least a portion of a signal. The receiver 14 may also include a memory operable to store data corresponding to signals and information provided by the photodiode 16, photodiodes 18, 20, and/or circuitry 26. For example, the memory provided by the receiver 14 may store data corresponding to detected brightness levels and differences in detected brightness values over a plurality of frames.

In some embodiments, the circuitry 26 may include an operational amplifier 28 arranged as a voltage or current comparator to compare the output of the photodiodes 18, 20 and generate an output signal indicating the difference in brightness between the frame portions to which the photodiodes 18, 20 correspond. However, in some embodiments, and as shown in FIGS. 3, 5 and 7, the operational amplifier 28 may be configured as a differential amplifier operable to amplify a difference in signals provided by the photodiodes 18, 20. Such utilization of the operational amplifier 28 to both compare and amplify may be desirable due to the nominal outputs that may be provided by the photodiode 16 or photodiodes 18, 20.

However, as should be appreciated, the circuitry 26 may present any configuration operable to determine a difference between the signals provided by photodiodes 18, 20. Thus, in addition to the operational-amplifier configurations discussed above, the circuitry 26 may include processors, microcontrollers, programmable logic devices, digital signal processors, discrete analog and digital logic components, application specific integrated circuits, combinations thereof, etc.

As shown in FIG. 7, in embodiments wherein only one photodiode 16 is employed, the circuitry 26 may amplify the signal provided by the photodiode 16 and store the signal in memory for later comparison by other circuitry elements, as is discussed in more detail below.

In various embodiments, the circuitry 26 may also include low-pass and high-pass filters to filter signals provided by the photodiode 16 or photodiodes 18, 20 to desired ranges. For example, in some embodiments the circuitry 26 may include a low-pass filter to remove frequencies above approximately 50 Hz and a high-pass filter to remove frequencies below approximately 1 Hz. Further, the low-pass and high-pass filters may be employed to filter the output of the operational amplifier 28 instead of, or in addition to, filtering of the signals provided by the photodiode 16 or photodiodes 18, 20.

The circuitry 26 is preferably coupled with a power source, which may be integral or discrete from the receiver 14. In some embodiments, the power source may be integral with the receiver 14, such as where the power source comprises batteries for powering the circuitry 26. Additionally or alternatively, the power source may comprise conduits or connectors for connecting the circuitry 26 to a power supply, such as universal serial bus (USB) port provided by a computing element and/or other external AC and DC sources.

To facilitate alignment with the television 12, the receiver 14 may include alignment indicators, such as a plurality of light-emitting diodes, which illuminate when the receiver 14 is properly aligned with the television 12. Further, the receiver 14 may also include a low-power laser to allow viewers of the television 12 to easily and appropriately align the receiver 14 and television 12.

The receiver 14 may also include a housing 30 for retaining various portions of the photodiode 16 or photodiodes 18, 20, the POV cone 22, and the circuitry 26. In embodiments where the power source is integral with the receiver 14, the housing 30 may also house at least a portion of the power source or a connector for coupling with an external power source.

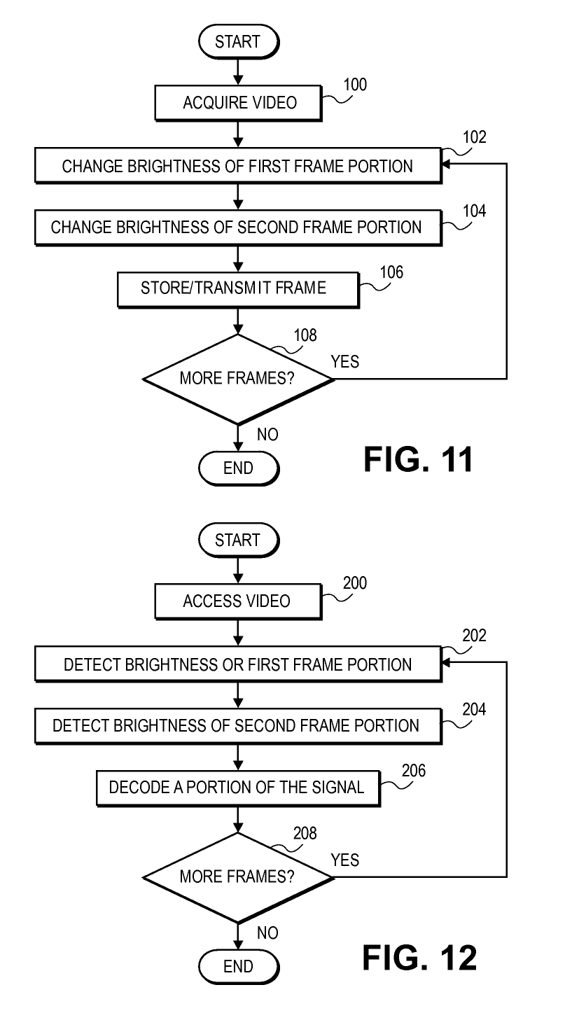

A flowchart of steps that may be utilized by various embodiments of the present invention to encode a signal within a video is illustrated in FIG. 11. Some of the blocks of the flow chart may represent a code segment or portion of code of the computer program of the present invention that comprises one or more executable instructions for implementing the specified logical function or functions.

The functions noted in the various blocks in FIG. 11 and discussed below may occur out of the order depicted in FIG. 11. For example, two blocks shown in succession in FIG. 11 may in fact be executed substantially concurrently, or the blocks may sometimes be executed in the reverse order depending upon the functionality involved. Further, any combination of the steps discussed below may be performed and in some embodiments all steps are not necessarily performed.

The steps illustrated in FIG. 11 generally include acquiring video, referenced at step 100; changing a brightness of a first frame portion, referenced at step 102; changing a brightness of a second frame portion, referenced at step 104; storing and/or transmitting the modified frame, referenced at step 106; and determining if more frames are required for signal encoding, referenced at step 108.

In step 102, video is acquired. The acquired video may correspond to any collection of images. Preferably, the acquired video comprises a plurality of frames, wherein each frame represents a still image for display on a screen or monitor, such as the television 12. Each frame in turn comprises a plurality of pixels, each pixel presenting a color preferably defined in RGB color space by RGB color coordinates. For example, each pixel within each frame may present a color corresponding to red, green, and blue coordinates. However, the acquired video may be a substantially conventional video represented in any format.

The acquired video preferably is a digital video represented in any digital format. Thus, the acquired video may comprise pulse-code modulated (PCM) video data, corresponding to formats such as CCIR 601, MPEG-4, MPEG-2, MPEG-1, H.261, H.263, H.264 (AVC), combinations thereof, etc. The acquired video may additionally or alternatively correspond to formats such as Digital Betacam (Betacam IX), Digital-S, DV, MiniDV, HDV, DVCAM, DVCPRO, Digital8, MicroMV, combinations thereof, etc. Additionally, the acquired video may correspond to a collection of discrete images, such as a plurality of bitmaps, GIFs, JPEGs, etc., instead of the various video formats discussed above.

Further, in some embodiments the acquired video may be in an analog format and converted to an appropriate digital format by the computer 10 or other equipment. Thus, the acquired video is not necessarily in a digital video format in all embodiments. The video may also be created or formed on the computer 10 such that the video is not necessarily generated by external sources.

The video may be acquired utilizing various methods. For instance, the computer 10 may acquire the video from a computer-readable medium, such as a hard drive, a flash memory element, and/or an optical medium such as a DVD, etc. Further, the computer 10 may also acquire the video through a computing network, such as the Internet or a LAN, utilizing wired or wireless communications elements. Similarly, the computer 10 may capture the video over broadcast network, such as a cable TV network or radio-frequency broadcasts, using video capture cards or the like.

Further, in some embodiments, only a portion of the video need be acquired. For instance, the computer 10 may stream the video from various external sources and/or receive only a frame at a time. Thus, only a single frame of a video need be received to perform various embodiments of the present invention.

In step 102, a brightness of at least a portion of a first frame of the video acquired in step 100 is changed. Brightness as utilized herein is the amount of visible light of any color that appears to be generated by a frame when presented on the television 12. As the first frame is preferably represented in digital format and in RGB color space, brightness of light (or luminance) may be generally defined as:
Y=0.299*R+0.587*G+0.114*B

where R, G, and B represent red, green, and blue color coordinates in the RGB color space. Thus, for example, in a 24-bit representation, a yellow pixel may have RGB coordinates of (255, 255, 0). The corresponding brightness of the yellow pixel would thus be 226. Similarly, in some embodiments the present invention may utilize the brightness of particular color portions or colors that comprise a pixel instead of, or in addition, a brightness based on a combination of color portions. For example, the brightness of the yellow pixel discussed above may include a red brightness portion having a value of 255, a green brightness portion having a value of 255, and a blue brightness portion having a value of 0.

As should be appreciated by those skilled in the art, embodiments of the present invention may employ any color space and color model and are not limited to the RGB color space and coordinates discussed above. For example, the brightness of the portion of the first frame may correspond to the YUV (luminance and chrominance) system, HSB (hue, saturation, brightness) coordinates, and/or the amplitude of light provided by the portion of the first frame.

The first frame portion to which the changed brightness corresponds in step 102 may comprise any portion of the first frame, including the entire frame. However, the first frame portion preferably corresponds to a portion of the frame smaller than entire frame. More preferably, the first frame portion corresponds to the portion of the frame viewable by one of the photodiodes 18, 20 when displayed on the television 12. For example, should the first photodiode 18 be configured to view the left side of the television 12 and the second photodiode 20 be configured to view the right side of the television 12, the first frame portion would preferably also correspond to the left side of the television 12 such that modifications to the brightness of the first frame portion may be detected by the photodiode 18 and related circuitry 26, as is discussed below in step 202. Thus, where n photodiodes are employed by the receiver 14, the first frame portion may correspond to some 1/n area of the first frame.

The brightness of the first frame portion is changed to encode at least a portion of a signal therein. Preferably, the signal to be encoded is a binary signal such that each frame of the video may present a first or second binary value. However, non-binary signals may also be encoded within the video by various embodiments of the present invention, such as by encoding and detecting more than two levels of brightness, by employing more than two photodiodes, and/or by utilizing more than one frame for each signal element. Similarly, the brightness of the first frame may be changed to encode a plurality of binary values therein.

In preferred embodiments where the brightness of the first and second frame portions are changed to encode a binary signal, the brightness of the first frame portion is increased or decreased to indicate the first binary value and the second binary value respectively. For example, the brightness of the first frame portion may be increased to encode a one on the first frame and the brightness of the first frame portion may be decreased to encode a zero on the first frame.

Thus, by changing the brightness of the first frame portion, embodiments of the present invention are operable to encode at least a portion of a signal on the frame such that the encoded signal may be decoded, in steps 200-208 discussed below, by viewing video including the frame when displayed on the television 12 with the receiver 14 and/or other equipment. Consequently, embodiments of the present invention do not require specific equipment, such as a CRT monitor, for displaying the brightness-modified frame.

The brightness of the first frame portion may be changed any amount in step 102. However, the brightness of the first frame portion is preferably changed such that it is not readily perceptible when viewed by a viewer of the television 12. Thus, embodiments of the present invention allow at least a portion of a signal to be encoded on the first frame portion, the first frame portion to be displayed on the television 12 as part of a video without interfering with the viewers' watching of the video, and the signal to be decoded as discussed below in steps 200-208.

In some embodiments, the brightness of the first frame portion is changed by less than about five percent, as many viewers have difficulty perceiving brightness changes of this amount. However, the brightness may be changed by any amount operable to be detected by the photodiode 16 or photodiodes 18, 20 discussed above. Preferably, the brightness of the first frame portion is changed by less than about two percent, and more preferably by less than about one percent, as such changes are sufficient to enable sensing by the photodiodes 18, 20 while evading detection by viewers watching the television 12.

In embodiments where the first frame portion includes pixels corresponding to the RGB color system, the brightness of the first frame portion is changed by proportionally changing the red, green, and blue coordinates of at least some of the pixels within the first frame portion.

In some embodiments a constant value may be added to each red, green, and blue coordinate of a pixel to increase the brightness of the pixel. For example, in embodiments where a 24-bit RGB color system is used, a value of 0.5 may be added to each red, green, and blue coordinate of a pixel to increase its brightness. For instance, a pixel having RGB coordinates of 150, 100, 50 may have its brightness increased by adding 0.5 to each coordinate, resulting in RGB coordinates of 150.5, 100.5, and 50.5. Similarly, a value of 0.5 may be subtracted from each red, green, and blue coordinate of a pixel to decrease its brightness. As should be appreciated, any constant value may be added or subtracted from RGB coordinates to increase or decrease the brightness of a pixel any desired amount.

In addition to or as an alternative to the constant addition and subtraction discussed above, embodiments of the present invention may change the brightness of a pixel by a variable amount. Preferably, the variable amount corresponds to the original brightness of a pixel such that the change in brightness of the pixel is at least partially dependent upon its original brightness. For example, to increase the brightness of a pixel, a variable amount corresponding to 0.01 of each red, green, and blue color coordinate may be added to or subtracted from the respective color coordinates. For instance, a pixel having RGB coordinates of 150, 100, 50 may have its brightness increased by adding 1.5 to the red coordinate, 1 to the green coordinate, and 0.5 to the blue coordinate, resulting in RGB coordinates of 151.5, 101, and 50.5. As should be appreciated, any variable value may be added or subtracted from RGB coordinates to increase or decrease the brightness of a pixel any desired amount.

Such variable addition and subtraction of brightness based on the original brightness of a pixel may be desirable as it increases brightness for detection by the photodiode 16 or photodiodes 18, 20 while ensuring that the brightness increase is not detected by viewers of the television 12. This is consistent with studies of the human visual system which show that sensitivity to a brightness change is generally proportional to the original brightness level.

As is discussed in more detail below, in various embodiments it is preferable to change the brightness of a pixel by using both the constant and variable values discussed above. Utilization of both constant and variable values for increasing and decreasing brightness further ensures that the photodiode 16 or photodiodes 18, 20 are operable to detect the increase or decrease in brightness while also generally preventing viewers of the television 12 from noticing the increase or decrease in the brightness.

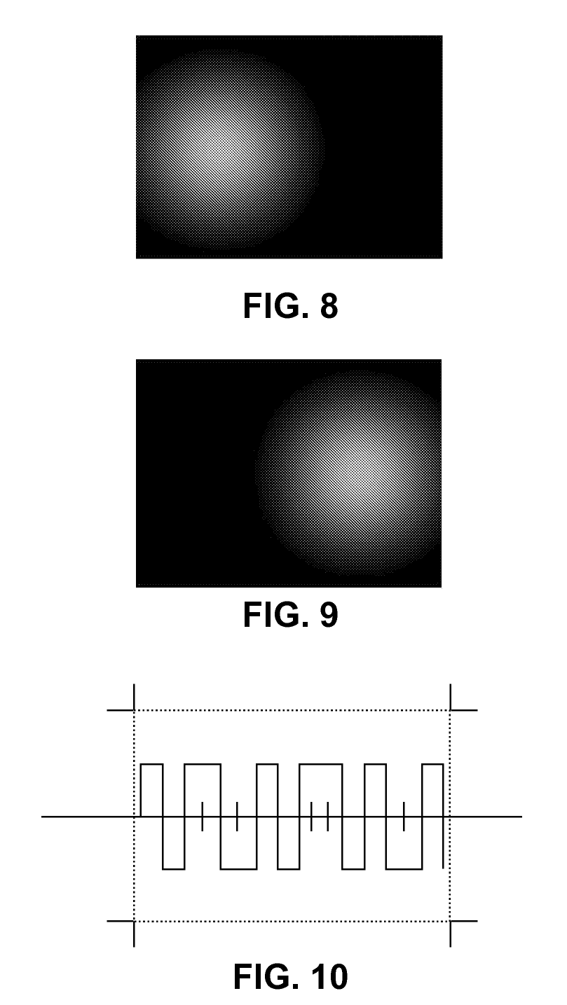

To enable the photodiode 16 or photodiodes 18, 20 to detect the increase or decrease in brightness of the first frame portion, the brightness of a plurality of pixels within the first frame portion is preferably increased or decreased. For instance, as shown in FIG. 8, an exemplary pixel distribution for a first frame portion comprising the left side of a frame is shown indicating the pixels that have increased brightness. The pixel distribution of FIG. 8 may be added to any frame to increase the brightness of its first frame portion, thereby encoding the first binary value therein. The pixel distribution of FIG. 8 may also be subtracted from any frame to decrease the brightness of its first frame portion, thereby encoding the second binary value therein. However, as should be appreciated, the brightness of any number of pixels within the first frame portion may be changed to allow detection by the photodiode 16 or photodiodes 18, 20.

Preferably, a Gaussian window is used to change the brightness of a plurality of pixels within the first frame portion such that pixels at the center of the Gaussian distribution have a greater change in brightness than those at the fringes of the Gaussian distribution. The exemplary pixel distribution of FIG. 8 shows the use of a Gaussian window where pixels at the center of the Gaussian distribution are brighter than those at the fringes, even though all pixels initially have the same brightness (black). Utilization of a Gaussian window, as opposed to uniform increases and decreases in brightness, is desirable as it less noticeable to viewers of the television 12. The Gaussian window employed by embodiments of the present invention may be any type of Gaussian, or normal, distribution, including the Gaussian distribution given by:
G(x,y)=e^{-((x-x}^{_{c}}⁾^{²}^{+(y-y}^{_{c}}⁾^{²}^{)/(2σ}^{²}⁾

where x and y are the spatial coordinates of a particular pixel, σ is the standard deviation of the Gaussian distribution, and x_{c}, y_{c} represent the center of the Gaussain window.

Instead of the Gaussian distribution discussed above, a raised-cosine pattern or other window function may be employed to determine which pixels within the first frame portion should be modified. In particular, any window function which modifies pixels within the center of an area more than pixels along the edge of the area may be employed to reduce the prominence of brightness changes. Additionally, embodiments of the present invention may employ a generally random distribution, defined by a random-number generator for example, to determine which pixels should be modified. Further, the utilized pattern may be dependent upon the image represented by the first frame portion, such as by using image-processing algorithms to identify brightness modifications that may be made to the image without being detectable by the viewers of the television 12.

In some embodiments, a generally random noise (dither) value may be applied to the pixels to further present a non-uniform change in brightness. This dither value may allow change in brightness of the frame by a fractional value for a digitally encoded frame. The random noise value may be a positive or negative value with generally zero mean value so that by itself it does not add any brightness to the frame. The random noise value is preferably a value significantly less than the constant and variable brightness values discussed above to prevent the noise value from degrading the video.

In various preferred embodiments, the red, green, and blue coordinates of each pixel within the first frame portion is changed using both the constant, variable, Gaussian, and noise values discussed above. In such embodiments, the resulting color coordinates for each pixel (P) within the first frame portion may be represented by:

$$P ( x , y ) = \begin{matrix}( R + b ( t ) * C * m ( x , y ) + b ( t ) * V * R * m ( x , y ) + C * n ( x , y ) , \\ G + b ( t ) * C * m ( x , y ) + b ( t ) * V * G * m ( x , y ) + C * n ( x , y ) , \\ B + b ( t ) * C * m ( x , y ) + b ( t ) * V * B * m ( x , y ) + C * n ( x , y ) ) ,\end{matrix}$$

where R, G, and B represent the red, green, and blue color coordinates of the pixel P at x,y, m(x,y) represents the Gaussian window, n(x,y) represents the generally random noise value, C represents the constant brightness value, V represents the variable brightness value, and b(t) represents whether brightness is being increased or decreased (a b(t) value of 1 indicates that brightness is being increased while a b(t) value of −1 indicates that brightness is being decreased).

Thus, for example, where P(x,y) represents a generally magenta pixel (255, 0, 255) positioned within the first frame portion, brightness is being increased to encode the first binary value, C is 0.5, and V is 0.01, the resulting RGB coordinates for the modified pixel would be:

$$P ( x , y ) = \begin{matrix}( 255 + 1 * 0.5 * m ( x , y ) + 1 * 0.01 * 255 * m ( x , y ) + 0.5 n ( x , y ) , \\ 0 + 1 * 0.5 m ( x , y ) + 1 * 0.01 * 0 * m ( x , y ) + 0.5 n ( x , y ) , \\ 255 + 1 * 0.5 * m ( x , y ) + 1 * 0.05 * 255 * m ( x , y ) + 0.5 n ( x , y ) ) .\end{matrix}$$

However, the brightness of the first frame portion may be increased or decreased utilizing any methods, and the present invention is not limited to the various RGB coordinate value modifications discussed above. For instance, the brightness of the first frame portion may be increased by increasing the white content of the pixels comprising the first frame portion regardless of the specific RGB coordinates of the pixels. Further, in embodiments where the first frame portion does not include pixels corresponding to the RGB color model, the brightness of various pixels may be increased or decreased by changing the white content or intensity of the pixels.

In step 104, a brightness of a second frame portion is changed. The second frame portion corresponds at least partially to a portion of the frame that is different than the first frame portion. For instance, in embodiments where the first frame portion corresponds to a left side of the frame, and thus the left side of the television 12, the second frame portion may correspond to a right side of the frame, and thus the right side of the television 12. However, the second frame portion may correspond to any portion of the frame, including the top or bottom of the frame.

Preferably, the brightness of the second frame portion is changed by modifying the brightness of at least one of the pixels that comprises the second frame portion, as shown in FIG. 9. The brightness of pixels within the second frame portion may be modified as discussed above in step 104, such as by adding or subtracting constant and/or variable values from a pixel's RGB coordinates. Similarly, Gaussian windows and generally-random noise values may be used to change the brightness of the second frame portion in a manner that evades detection by viewers of the television 12.

In various embodiments, the change in the brightness of the second frame portion depends on the change in the brightness of the first frame portion made in step 102. To facilitate proper detection of signals by the photodiodes 18, 20, the change in the brightness of the second frame portion is preferably opposite the change in the brightness of the first frame portion. Such a configuration reduces false detection of encoded signals by the photodiodes 18, 20 by providing a method of common-mode rejection, as is discussed below in step 206 in more detail.

In embodiments where the brightness of the first frame portion is increased to encode the first binary value on the first frame, the brightness of the second frame portion may be decreased. In embodiments where the brightness of the first frame portion is decreased to encode the second binary value on the first frame, the brightness of the second frame portion may be increased. As should be appreciated, the reverse configuration may be employed to encode the first and second binary values as well.

Further, in some embodiments, the brightness of the second frame portion may be changed in the same manner as the brightness of the first frame portion. For example, both the brightness of the first frame portion and the second frame portion may be increased to encode the first binary value or decreased to encode the second binary value. Such a configuration may be desirable in embodiments where only one photodiode 16 is utilized or where the photodiodes 18, 20 may be unable to detect a change in brightness of only one of the frame portions.

Step 104 is not necessarily performed in all embodiments as changing the brightness of only the first frame portion may be sufficient to encode a portion of a signal on the frame, such as where only one photodiode 16 is utilized and/or where the first frame portion comprises the entire frame.

Further, although steps 102 and 104 are preferably applied to the same frame, step 102 may be applied to a first frame and step 104 may be applied to a second frame, such that two frame portions may be utilized to encode one binary value without changing the brightness of two portions of a single frame.

Additionally, in embodiments where more than two frame portions are utilized to encode the signal, such as where the receiver 14 includes more than two photodiodes, step 104 may be performed for each additional frame portion within the frame. For instance, by utilizing four frame portions, two binary values may be encoded within a single frame, by utilizing eight frame portions, four binary values may be encoded within a single frame, and/or more than two frame portions may be utilized to encode only one binary value, such as where the brightness of a plurality of frame portions is aggregated by the receiver 14, as is discussed in more detail below.

In step 106, the frame including the first frame portion, second frame portion, and/or any other frame portions is stored and/or transmitted. The frame may be stored as part of the video from which it originated, such as by saving the frame as part of a digital video file for later playback on the television 12. Thus, the frame may be saved as a portion of a video and stored within a computer-readable memory, including but not limited to random access memories, read only memories, flash memories, magnetic memories such as hard disks, optical memories such as DVDs and HD-DVDs, combinations thereof, etc. The computer-readable memory comprising the video and any frames including portions of the signal encoded thereon, may then be distributed for use and/or used in combination with the television 12 to display the video and allow decoding of the signal.

Additionally or alternatively, the frame may be transmitted, such as through a computing network, cable network, or a broadcast network for reception and viewing by the television 12. For instance, the frame as modified in steps 102 and 104 may be broadcast over TV frequencies or a cable network for reception by the television 12 and/or sent as data through the Internet to allow reception and play by the television 12. Thus, the frame may be streamed through various networks independent of the video to which it corresponds such that various embodiments of the present invention may be performed on the fly without requiring encoding of an entire signal before transmission.

Thus, in various embodiments, the frame may be stored, saved, distributed, and transmitted in the same manner as conventional video frames without requiring changes to the television 12, computer 10, other associated electronic components, computing networks, broadcast networks, etc.

In step 108, the number of frames required to encode the signal is determined and steps 100 through 106 are repeated until the signal is appropriately encoded on a plurality of frames. For example, to encode a 10-bit signal by changing the brightness of two frame portions within each frame, ten frames may be modified through repetition of steps 100-106. Alternatively, as discussed above, any number of frame portions may be modified in steps 102 and 104 such that a n-bit signal may encoded using any number of frames. Further, as should be appreciated by those skilled in the art, the n-bit signal encoded on one or more frames may also include one or more bits for error checking and/or synchronization.

Thus, by utilizing one or more frames each having one or more frame portions, any binary or non-binary signal may be encoded by embodiments of the present invention. For instance, the exemplary signal waveform shown in FIG. 10, comprising a 15-bit signal—101100101101001, may be encoded by embodiments of the present invention by altering the brightness of fifteen frames of video, such as by increasing or decreasing the brightness of first and/or second frame portions as discussed above.

Standard television frame rates in the U.S. are approximately 1/30 second per frame. Thus, the maximum bit rate operable to be achieve by embodiments of the present invention that encode a single binary value on each frame for display on U.S. televisions would be approximately 30 bits per second. However, by encoding multiple binary values on a single frame, such as a by using more than two frame portions and more than two photodiodes or by using more than one level of brightness for each frame portion, faster bit rates may be achieved. In some embodiments, it may be desirable to employ a bit rate less than 30 bits per second to further prevent brightness changes from being detected by viewers of the television 12 or to improve detection by the receiver 14.

The video that includes the encoded signal may itself inherently include changes in brightness of various frame portions. For example, a video which transitions from a dark sky to the moon could inadvertently cause an increase in brightness and result in decoding errors. To prevent common variations in the video from being detected as encoded signals by the receiver 14, the encoding performed by steps 100-106 may include low frequency limits. For example, only four zeros or ones may be allowed in a row (corresponding to 2/15ths of a second on US televisions) such that the receiver 14 may take into consideration the immediate past history of brightness changes including the requirement that variations due to the encoded signal must be present in every group of four frames. As should be appreciated, any frequency limit may be employed by embodiments of the present invention to prevent biasing of the encoded signal by underlying video content.

A flowchart of steps that may be utilized by various embodiments of the present invention to decode a signal within a video is illustrated in FIG. 12. Some of the blocks of the flow chart may represent a code segment of the computer program of the present invention that comprises one or more executable instructions for implementing the specified logical function or functions. In some alternative implementations, the functions noted in the various blocks of FIG. 12 may occur out of the order depicted. For example, two blocks shown in succession in FIG. 12 may in fact be executed substantially concurrently, or the blocks may sometimes be executed in the reverse order depending upon the functionality involved. Further, any combination of the steps discussed below may be performed and in some embodiments all steps are not necessarily performed.

The steps illustrated in FIG. 12 generally include accessing a video, referenced at step 200, detecting a brightness of a first frame portion, referenced at step 202, detecting a brightness of a second frame portion, referenced at step 204, decoding a portion of an encoded signal, referenced at step 206, and determining if more frames are required for signal decoding, referenced at step 108.

In step 200, at least a portion of a video is accessed. The accessed video or video portions correspond to the video frames stored and/or transmitted in step 106. Thus, the video, including one or more frames, may be accessed by coupling the television 12 with the computer-readable medium, such as a DVD, and playing video data stored on the computer-readable medium on the television 12. Similarly, the video, including one or more frames, may be accessed by receiving transmitted frames through the Internet, other computing networks, cable networks, broadcast TV frequencies, etc, and displaying the received frames on the television 12. Thus, the entire video need not be accessed at the same time.

In step 202, a brightness of the first frame portion, modified in step 102, is detected. The receiver 14 may be oriented towards the television 12 to enable detection of the first frame portion brightness. For example, in embodiments where the frame includes two frame portions, the photodiodes 18, 20 may be aligned such that the first photodiode 18 is operable to detect the brightness of the first frame portion and the second photo diode 20 is operable to detect the brightness of the second frame portion. Specifically, the FOV cone or cones 22 may be aligned with appropriate portions of the television 12. As discussed above, the receiver 14 may include alignment indicators and elements, such as LEDs and lasers, to facilitate alignment of the receiver 14 and television 12 by viewers.

After proper alignment with the television 12, the first photodiode 18 may detect the brightness of the first frame portion and generate a signal corresponding to the detected brightness. As discussed above, in some embodiments, more than one photodiode may be used to detect the brightness of a frame portion, such that step 202 may include using any number of photodiodes, or other elements, to detect the brightness of the first frame portion.

In step 204, a brightness of the second frame portion, modified in step 104, is detected. The receiver 14 is preferably aligned with the television 12 in step 202 such that the receiver 14 need not be realigned in step 204 or other steps. Preferably, the second photodiode 20 detects the brightness of the second frame portion and generates a signal corresponding to the detected brightness. However, as discussed above, any number of photodiodes, including the same photodiodes used in step 202, may be used to detect the brightness of the second frame portion.

Additionally, as is discussed above in step 104, the brightness of the second frame portion is not necessarily detected in all embodiments, as some embodiments of the present invention may utilize only the brightness of the first frame portion to encode the signal. Further, step 204 may be repeated in embodiments where the frame includes more than two frame portions, such that the brightness of each frame portion changed in steps 100-108 may be detected.

In step 206, at least a portion of the signal is decoded utilizing the frame portion brightness detected in steps 202 and 204. Preferably, the circuitry 26 receives the signals provided by the photodiode 16 or photodiodes 18, 20 and decodes the encoded signal based upon differences in detected brightness. For example, in embodiments where two frame portions are utilized to encode a binary value in one frame, the circuitry 26 may detect that the first frame portion is brighter than the second frame portion, based on the signals provided by the photodiodes 18, 20, and decode the first binary value. Similarly, the circuitry 26 may detect that the first frame portion is darker than the second frame portion and decode the second binary value.

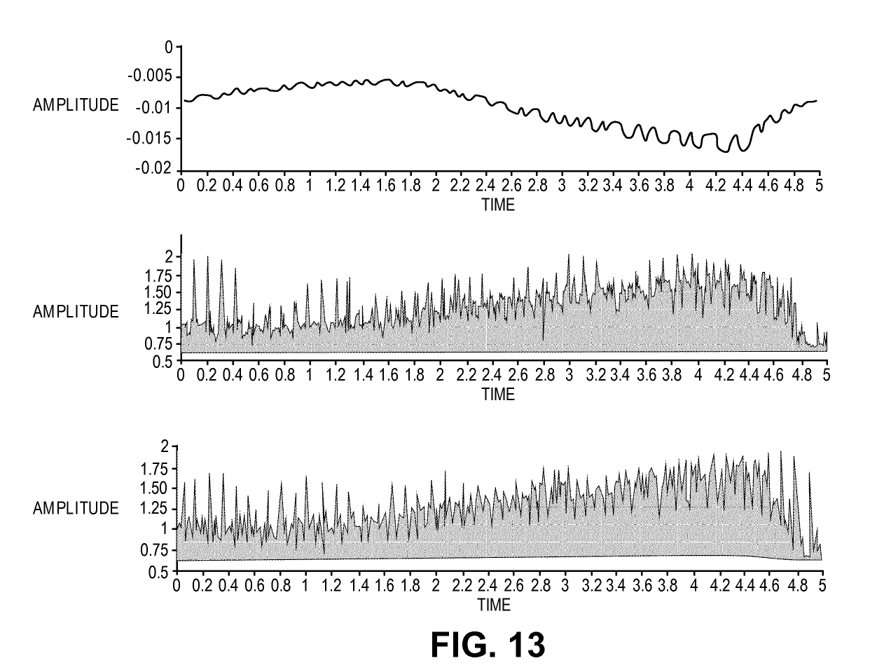

The resulting decoded value may be output by the circuitry 26 for use by other components, such a computing devices coupled with the circuitry 26. Exemplary waveforms corresponding to a decoded signal formed from the difference between two photodiode output signals are shown in FIG. 13.

In embodiments employing the single photodiode 16, the circuitry 26 is operable to compare the brightness of the frame portion to which the single photodiode 16 corresponds to previously detected brightness levels and decode a signal based on the results. Further, the circuitry 26 may compare signals provided by any number of photodiodes corresponding to any number of frame portions to correspond to any encoding method discussed above.

In decoding the encoded signal, the difference signal generated by the circuitry 26 through comparison of the photodiode 18, 20 outputs is preferably filtered using the low-pass and high-pass filters discussed above. Specifically, frequencies above 30-50 Hz and below 1-5 Hz are preferably filtered from the difference signal to eliminate signal artifacts caused by unbalanced video information presented on the television 12. Thus, should the underlying video displayed the television 12 inherently include a first frame portion that is brighter than a second frame portion, or the opposite, the circuitry 26 filtering facilitates accurate artifact correction and proper decoding of signals.

In some situations, as shown in first waveform of FIG. 13, the underlying video may present a gradual and generally linear increase or decrease in brightness that may adversely affect the ability of the circuitry 26 to decode signals. In such embodiments, the circuitry 26 may be operable to fit a straight line to the difference signal over a region of multiple frames to estimate the baseline for detection of binary values encoded within the frames. To allow for more complex scene changes within the underlying video, the curve that is fit to the difference signal may be a higher order, such as a quadratic curve.

In various embodiments, the circuitry 26 does not necessarily generate the difference signal based on the difference between signals generated by the photodiodes 18, 20. For example, in embodiments where the brightness of more than two frame portions is changed in steps 100-108, the brightness of the more than two frame portions may be detected in steps 202 and 204 and the circuitry may determine an overall change in brightness based on an aggregation of the detected brightness of the various frame portions. The preferred aggregation method is by mode, i.e. the most frequently occurring change, thus eliminating outliers caused by scene changes within the underlying video. In such embodiments the receiver 14 may be made less sensitive to alignment with the television 12 by using image processing methods and elements to locate appropriate detection areas within displayed frames.

In step 208, steps 200-206 are repeated until the signal is at least partially decoded. In some embodiments, the receiver 14 may be used to continuously monitor the television 12 to decode any signals encoded within displayed video. In other embodiments, the receiver 14 may cease monitoring the television 12 upon satisfaction of a condition, such as decoding of a complete signal or upon decoding a termination bit.

Through repetition of steps 200-206, the circuitry 26 may provide an output signal indicating the resulting decoded signal. In embodiments where two frame portions are used and the circuitry 26 is operable to determine the difference in brightness between the two frame portions, the output signal may correspond to the difference signal that reflects the difference in brightness between the two photodiodes 18, 20. However, in other embodiments the signal output by the circuitry 26 may correspond to other comparisons or calculations, as is discussed above.

Consequently, by encoding data as discussed above in steps 100-108 and decoding data as discussed above in steps 200-208, embodiments of the present invention enabled data to be encoded on the visible portion of video frames for display by projectors, televisions, and monitors of all types and thus the present invention is not dependent upon CRT technology. Further, the encoding and decoding methods discussed herein may be employed even in situations where video is compressed for storage and transmission and decompressed for viewing without adversely affecting the utilized compression methods.

Various embodiments of the present invention may be employed to: produce an interactive television environment, such as by simultaneously displaying a television show and encoding information corresponding to the show for consumption by a viewer; provide data and information for electronic toys and video games, such as toys that interact with videos displayed on the television 12; enable digital rights management, such as by equipping a conventional DVD player with the receiver 14 to ensure that played DVDs are legitimate; enable monitoring of television and advertising viewing statistics; combinations thereof; and the like.

Although the invention has been described with reference to the preferred embodiment illustrated in the attached drawing figures, it is noted that equivalents may be employed and substitutions made herein without departing from the scope of the invention as recited in the claims.

For example, instead of changing the overall brightness of frame, various embodiments of the present invention may change color levels or color portions, such as just the red coordinate or green coordinate of a RGB pixel, for detection by color-sensitive optical detectors. Such color-based modifications may be employed in addition to or as an alternative to the overall brightness-based modifications discussed above.

Further, instead of utilizing only an increase and a decrease in frame portion brightness to encode and decode signals, various embodiments of the present invention may use more than two brightness levels to enable additional bits and information to be transmitted in each frame. For example, two frame portions within each frame may be increased or decreased by one percent or two percent, thereby providing a total of sixteen possible brightness combinations for each frame that may be detected by the receiver 14.

Furthermore, instead of changing the brightness of fixed frame portions, various embodiments of the present invention may select the position of the first portion of the frame and the second portion of the frame based on the content of the original and un-encoded frame, and/or video, in order to minimize the recognizable visibility of brightness changes caused by the encoded signal. For example, changes in brightness made near large or fast-moving edges in the video are less noticeable to a human than the same magnitude of changes in a constant region of the video. Thus, in some embodiments the receiver 14 may detect portions of the frame having large or fast-moving edges, such as by storing frame and brightness information within its memory, and select the position of the first portion and/or second portion based on a comparison of current and past frame information.

Having thus described the preferred embodiment of the invention, what is claimed as new and desired to be protected by Letters Patent includes the following:

1. A method of encoding a signal within a video including at least one frame, the method comprising:
increasing a brightness of a first portion of a first frame by less than about five percent;
decreasing a brightness of a second portion of the first frame by less than about five percent; and
storing the first frame as a portion of the video.

2. The method of claim 1, further comprising:
decreasing a brightness of a first portion of a second frame by less than about five percent;
increasing a brightness of a second portion of the second frame by less than about five percent; and
storing the second frame as a portion of the video.

3. The method of claim 2, wherein the first portion of the first frame and the first portion of the second frame each correspond to a left side of the frames and the second portion of the first frame and the second portion of the second frame each correspond to a right side of the frames.

4. The method of claim 2, wherein—
increasing the brightness of the first portion of the first frame and decreasing the brightness of the second portion of the first frame encodes a first binary value in the first frame, and
decreasing the brightness of the first portion of the second frame and increasing the brightness of the second portion of the second frame encodes a second binary value in the second frame.

5. The method of claim 1, wherein the first portion of the first frame includes a plurality of pixels, each of the pixels having RGB coordinates, the brightness of the first portion of the first frame being increased by increasing the RGB coordinates of at least one of the pixels.

6. The method of claim 5, further including selecting the position of the first portion of the first frame and the second portion of the first frame based on the original content of the first frame.

7. The method of claim 5, wherein the RGB coordinates of at least one of the pixels are increased by adding a constant value thereto.

8. The method of claim 5, wherein the RGB coordinates of at least one of the pixels are increased by adding a variable value thereto, the variable value corresponding to the brightness of the pixels.

9. The method of claim 1, further including applying a window function to at least a portion of the first portion of the first frame.

10. The method of claim 1, further including transmitting the first frame for display on a television.

11. The method of claim 1, wherein the brightness of the first portion of the first frame is increased by less than about two percent and the brightness of the second portion of the first frame is decreased by less than about two percent.

12. The method of claim 1, wherein the first portion of the first frame includes a plurality of pixels and the brightness of the first frame portion is increased by changing at least one color portion of at least one of the pixels.

13. A method of decoding a signal within a video including at least one frame, the method comprising:
detecting a brightness of a first portion of a first frame;
detecting a brightness of a second portion of the first frame;
determining a difference in the brightness of the first portion from the brightness of the second portion; and
based upon the difference in brightness, decoding at least a portion of the signal within the first frame.

14. The method of claim 13, further including—
detecting a brightness of a first portion of a second frame;
detecting a brightness of a second portion of the second frame;
determining a difference in the brightness of the first portion of the second frame from the brightness of the second portion of the second frame; and
based upon the difference in brightness, decoding at least a portion of the signal within the second frame.

15. The method of claim 14, wherein the first portion of the first frame and the first portion of the second frame each correspond to a left side of the frames and the second portion of the first frame and the second portion of the second frame each correspond to a right side of the frames.

16. The method of claim 14, further including comparing the determined difference in brightness of the first portion of the second frame and the second portion of the second frame with the determined difference in brightness of the first portion of the first frame and the second portion of the first frame and decoding at least a portion of the signal based on the comparison.

17. The method of claim 13, wherein—
a first binary value is decoded when the brightness of the first portion of the first frame is greater than the brightness of the second portion of the first frame, and
a second binary value is decoded when the brightness of the first portion of the first frame is less than the brightness of the second portion of the first frame.

18. The method of claim 13, wherein the video is displayed on a television and the brightness of the portions is detected by using at least one photodiode oriented towards the television.

19. An apparatus for decoding a signal within a video including at least one frame displayed on a television, the apparatus comprising:
a first photodiode operable to be oriented towards a first portion of the television to detect a brightness of a first portion of a first frame;
a second photodiode operable to be oriented towards a second portion of the television to detect a brightness of a second portion of the first frame; and
circuitry operable to determine the difference in the brightness of the first portion from the brightness of the second portion and, based upon the difference in brightness, decode at least a portion of the signal within the first frame.

20. The apparatus of claim 19, wherein the circuitry is further operable to—
detect a brightness of a first portion of a second frame,
detect a brightness of a second portion of the second frame,
determine a difference in the brightness of the first portion of the second frame from the brightness of the second portion of the second frame, and
based upon the difference in brightness, decode at least a portion of the signal within the second frame.

21. The apparatus of claim 19, wherein—
the circuitry decodes a first binary value when the brightness of the first portion of the first frame is greater than the brightness of the second portion of the first frame, and
the circuitry decodes a second binary value when the brightness of the first portion of the first frame is less than the brightness of the second portion of the first frame.

22. The apparatus of claim 19, wherein the circuitry includes an operational amplifier.

23. The apparatus of claim 19, further including a field-of-view cone coupled with each photodiode to facilitate orientation of the photodiodes.

24. A method of decoding a signal within a video including a plurality of frames, the method comprising:
detecting a brightness of at least a portion of a first frame;
detecting a brightness of at least a portion of a second frame;
determining a difference in the brightness of the first frame from the brightness of the second frame; and
based upon the difference in brightness, decoding at least a portion of the signal.

25. The method of claim 24, wherein—
a first binary value is decoded when the brightness of the first frame is greater than the brightness of the second frame, and
a second binary value is decoded when the brightness of the first frame is less than the brightness of the second frame.

26. The method of claim 24, wherein the video is displayed on a television and the brightness of the frames is detected by using at least one photodiode oriented towards the television.
